(19) United States
(12) Patent Application Publication
(10) Pub. No.: US 2003/0031276 A1
(43) Pub. Date: Feb. 13, 2003

(54) Decoder, and an associated method, for decoding space-time encoded data

(76) Inventor: Adrian Boariu, Irving, TX (US)

Correspondence Address: Docket Clerk, P.O. Box 802432, Dallas, TX, 75380, US

(21) Appl. No.: 09/848,794

(22) Filed: May 4, 2001

(51) Int. Cl. H04L 27/06; H04L 1/02

(52) U.S. Cl. 375/340; 375/347

(57) ABSTRACT

Apparatus, and an associated method, for decoding space-time encoded data communicated to a receive station. Space-time encoded data is transmitted to the receive station upon two or more communication paths. During performance of decoding operations at the receive station, the data transmitted on the different communication paths is directly combined and, thereafter, the symbol values of the data, once combined, are detected.

The present invention relates generally to a manner by which to operate upon space-time encoded data communicated during operation of a communication system, such as a cellular, or other radio, communication system. More particularly, the present invention relates to apparatus, and an associated method, for decoding the space-time encoded data when received at a receive station. Indications of the space-time encoded data, communicated to the receive station upon two or more communication paths are directly combined and, thereafter, values of the data are detected. Detection of the values of the data communicated to the receive station is made by using reduced-complexity calculations relative to calculations conventionally required to detect the values of the data at a conventionally-constructed space-time decoder.

### BACKGROUND OF THE INVENTION

The use of communication systems through which to communicate data between separate locations is a necessary adjunct of modern society. A wide variety of different types of communication systems have been developed and are regularly utilized to effectuate communication of data between sending and receiving stations positioned at separate locations.

New types of communication systems, as well as improvements to existing types of communication systems, have been made possible as a result of advancements in communication technologies. Radio communication systems are exemplary of communication systems which have benefited from the advancements in communication technologies. Improvements to existing types of radio communication systems as well as new types of radio communication systems have been made possible as a result of the advancements in communication technologies.

An inherent increase in communication mobility is provided through the use of a radio communication system in contrast to communications effectuated through the use of a conventional wireline communication system. Communication channels defined between the sending and receiving stations of a radio communication system are defined upon radio links formed therebetween. The communication channels are referred to as radio communication channels and do not require fixed connections between the sending and receiving station for their formation.

Digital communication techniques are increasingly implemented in radio, and other, communication systems. The use of digital communication techniques permits the communication capacity of a communication system in which the techniques are implemented to be increased in contrast through the use of conventional, analog techniques. Also, digital communication techniques permit improvement in the quality levels of the communications effectuated in a communication system.

When digital communication techniques are utilized, data which is to be communicated by a sending station to a receiving station is digitized. Once digitized, the digitized information is formatted, such as into data packets, and converted into a form to permit its communication upon the communication channel to the receiving station.

In an ideal communication system, the data packets, subsequent to their transmission upon the communication channel and reception at a receiving station, are substantially identical in value to the corresponding data packets prior to their communication upon the communication channel.

In an actual communication system, however, distortion is introduced upon the data during its communication upon the communication channel such that the values of the data, when received at the receiving station, differ, at least in part, with corresponding values of the data packets prior to their communication upon the communication channel. If the amount of distortion is significant, the informational content of the data cannot accurately be recovered at the receiving station.

Multipath transmission upon the communication channel formed between the sending and receiving stations, for instance, causes fading of the data during its communication upon the communication channel. Such fading might alter the values of the symbols of the data, such as the symbols of a data packet, during transmission upon the communication channel. Alteration of the values of the of the symbols of the data during communication upon the communication channel is referred to as propagation distortion. If the propagation distortion is not properly corrected, the communication quality levels of the communications are, at a minimum reduced.

Various techniques are utilized to compensate for the propagation distortion introduced upon the data as a result of the communication of the data upon a nonideal communication channel. Increasing the transmit diversity of the data is utilized, for instance, to increase the likelihood that the informational content of the data can be recovered.

Time-encoding of the data, prior to its communication, is referred to as creating time diversity. When the data is time-encoded, the redundancy of the data is increased. Because of the increased redundancy, loss of portions of the data due to fading is less likely to prevent the recovery of the information content of the data.

Space diversity is also utilized to compensate for propagation distortion. Generally, space diversity refers to the utilization of more than one transmit antenna at a sending station at which to transduce the data. The antenna transducers are separated by distances great enough to ensure that the data communicated from the respective transducers fade in an uncorrelated manner. When uncorrelated, fading of the data transmitted upon one communication path to a receiving station is unlikely to fade in the same manner and at the same time as data communicated to the receiving station upon a different communication path.

Space and time diversity are sometimes utilized together, thereby further to enhance transmission diversity to combat propagation distortion resulting from fading caused by, e.g., multi-path transmission of data. Use of both space and time diversity is referred to as use of space-time diversity.

Space-time codes have been developed to achieve transmit diversity to compensate for communication of data upon channels susceptible to fading. Space-time encoding techniques, and apparatus to implement such coding techniques are used at a sending station operable in a communication system in which space-time coding is to be utilized.

While utilization of space-time encoding techniques advantageously provides transmit diversity to compensate for fading upon the communication channel, decoding of the space-time encoded data must be performed when the data is received at a receive station. Conventional space-time decoding techniques are, however, computationally intensive. The need to perform complex computational operations to decode the space-time data requires the use of circuitry capable of performing the computations to decode the space-time encoded data. And, processing delays are introduced while awaiting for completion of the computational operations are performed at the space-time decoder.

In a manner by which to reduce the complexity of operations required to be performed to permit decoding of space-time encoded data would therefore be advantageous.

It is in light of this background information related to the communication of space-time encoded data that the significant improvements of the present invention have evolved.

### SUMMARY OF THE INVENTION

The present invention, accordingly, advantageously provides apparatus, and an associated method, by which to operate upon space-time encoded data communicated during operation of a communication system, such as a cellular, or other radio communication system.

Through operation of an embodiment of the present invention, space-time encoded data communicated to a receive station is decoded, once received thereat. Indications of the space-time encoded data, communicated to the receive station upon two or more communication paths, are directly combined. Once combined, values of the data are detected, thereby to decode the space-time encoded data. By directly combining the indications received at the receive station, and detecting values of the data only once all of the information regarding a given symbol of the data has been properly combined, improved detection of the symbol values of the data is provided. Additionally, computational efficiencies are provided. Operations are performed upon real, instead of complex, matrices, and the sizes of the matrices upon which the operations are performed are smaller than the sizes of the matrices upon which operations are performed utilizing conventional decoding techniques.

In one aspect of the present invention, space-time encoded data is transmitted to a receive station upon two or more separate communication paths from a sending station. The sending station includes a first antenna transducer and a second antenna transducer spaced apart therefrom. The space-time encoded data is provided to the separate transducers to be transduced therefrom. The data, in electromagnetic form, is communicated upon separate communication paths through the receive station. Because the data is communicated upon separate communication paths, the levels of fading exhibited by the data communicated upon the separate communication paths are dissimilar. Therefore, the values of the data transmitted upon the separate paths differs when received at the receive station. At least one antenna transducer is located at the receive station to transduce the data received thereat and to generate electrical representations thereof. Conventional receive operations are performed upon the electrical representations generated by the antenna transducer at the receive station. Then, indications are provided to a decoder whereat direct combining is performed and, thereafter, detection is made of the values of the data based upon the combined indications.

In another aspect of the present invention, the space-time encoded data transmitted by a sending station upon separate communication paths to a receive station is formed of a block of data, and once received at the receive station, the indications of the block of data are directly combined. Thereafter, values of the symbols of the block of data are detected. Additional, conventional circuitry of the receive station thereafter operates upon the detected values formed by the decoder.

In one implementation, a decoder is provided for a mobile station operable in a cellular, or other radio, communication system which utilizes space-time block coding. Indication of space-time encoded data are communicated upon separate communication paths to the mobile station. Indications of the space-time encoded data are provided to the decoder at which the indications are directly combined. Thereafter, symbol values of the block of data are detected.

In accordance with the present invention, therefore, apparatus, and an associated method, is provided for a communication system in which space-time encoded data is transmitted at a first location and at least a second location for communication to a receive station. The space-time encoded data is decoded when received thereat. A decoder is coupled to receive indications of the space-time encoded data received at the receive station. The decoder directly combines values of the space-time encoded data transmitted from different ones of the first and at least second locations to the receive station and detects values of symbols of the data, once combined.

A more complete appreciation of the present invention and the scope thereof can be obtained from the accompanying drawings which are briefly summarized below, the following detailed description of the presently preferred embodiments of the invention, and the appended claims.

### BRIEF DESCRIPTION OF THE DRAWINGS

FIG. 1 illustrates a functional block diagram of a communication system in which an embodiment of the present invention is operable.

FIG. 2 illustrates a method flow diagram showing the method steps of the method of operation of an embodiment of the present invention.

### DETAILED DESCRIPTION OF THE INVENTION

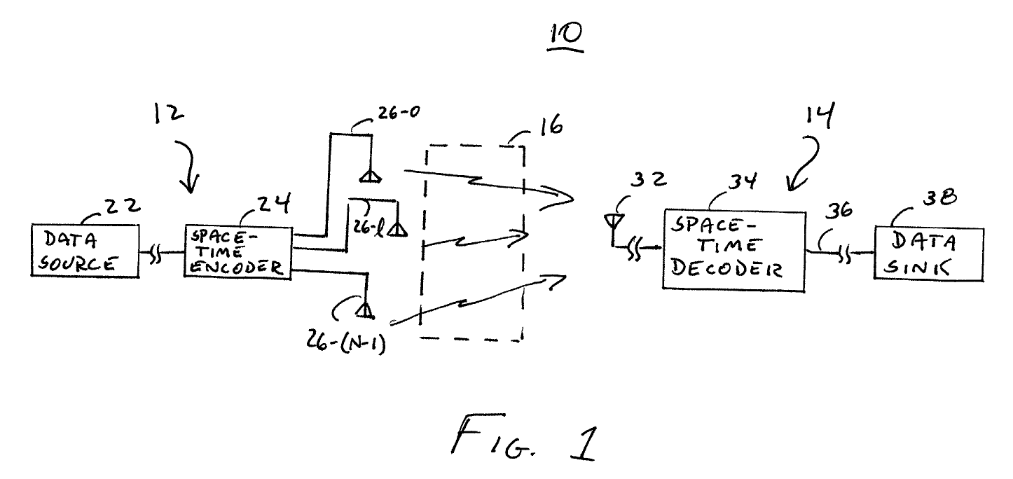

Referring first to FIG. 1, a communication system, shown generally at 10, is operable to communicate data between a sending station 12 and a receiving station 14. The communication of the data is effectuated upon a communication channel 16. A sending station, at which the data is sourced, is converted into a form to permit its communication upon the communication channel to a receive station 14. And, once received at the receive station, the informational content of the data is recreated.

In the exemplary implementation shown in the figure, the communication system 10 forms a radio communication system in which the communication channel 16 is defined upon a radio link formed of a portion of the electromagnetic spectrum. More particularly, the communication system 10 here forms a cellular communication system in which the sending station 12 here forms a base transceiver station (BTS), and the receive station here forms a mobile station operable of the cellular communication system.

While the following description shall describe operation of the communication system with respect to the exemplary implementation formed of a cellular communication system, it should be understood that operation of an embodiment of the present invention is analogously also operable in any communication system to facilitate communication of data between a sending station and a receive station upon a communication channel which is susceptible to fading, or other propagation distortion.

Data to be communicated by the base transceiver station 12 is sourced at a data source 22. While not separately shown, circuitry of the base transceiver station is operable to digitize, to source-encode, interleave, and to perform other processing functions upon the data. The data is then provided to a space-time encoder 24. The space-time encoder is operable to space-time encode the data provided thereto according to a space-time encoding technique. The space-time encoded data is provided to a plurality of antenna transducers 26-0 through 26-(M-1). Here, antenna transducers 26-0, 26-(l) and 26-(M-1) are shown in the figure. In an actual implementation, the encoding performed by the space-time encoder is related to the number of antenna transducers used at the base transceiver station to transduce data for communication to the mobile station 14. The antenna transducers 26 are spaced-apart such that the data transduced from individual ones of the antenna transducers are sent to the mobile station upon separate communication paths. Preferably, the communication paths upon which the data transduced by the separate ones of the antenna transducers are transmitted exhibit uncorrelated fading characteristics such that fading exhibited by the data transmitted on to separate communication paths fades at different rates, magnitudes, and times.

The mobile station includes one or more antenna transducers 32. Here, a single antenna transducer is utilized. In other implementations, greater numbers of antenna transducers are utilized at the mobile station. While not separately shown, conventional receive operations are performed upon the received data, once transduced into electrical form by the antenna transducer. The indications of the data received at the one or more antenna transducers 32 upon the plurality of communication paths is provided to space-time decoder 34 operable pursuant to an embodiment of the present invention.

The space-time decoder 34 is operable to decode the space-time encoding by which the data provided to the space-time encoder 24 is encoded. Pursuant to an embodiment of the present invention, the indications of the data provided to the space-time decoder representative of the data communicated upon each of the communication paths to the mobile station is first directly combined by the space-time decoder. Thereafter, i.e., subsequent to direct-combining operations, the space-time decoder is operable to detect values of symbols of which the data is formed. Values of the detections made by the decoder are generated on the line 36. Additional, conventional receive operations are performed upon the detected values. Then, the detected values to a data sink 38.

In contrast to conventional space-time decoders which to implement conventional space-time decoding techniques, operation of the space-time decoder of an embodiment of the present invention permits decoding operations to be performed through the utilization of real, rather than complex, matrices. And, the matrices are of smaller dimensions than dimensions of matrices conventionally required to be utilized. The complexity of operations required to be performed to detect values of the data transmitted by the base transceiver station to the mobile station is thereby reduced relative to operations conventionally required to be performed.

A mathematical representation of the formation of space-time encoded data for communication pursuant to operation of the communication system 10 and, also, corresponding decoding of the data by the space-time decoder 34 of an embodiment of the present invention illustrates advantageous operation of an embodiment of the present invention.

System operation shall be described with respect to M antenna transducers 26 and L receive antenna transducers 32. The subscripts of T, H, and * shall herein refer to transposition, Hermitian, and complex conjugation operators. The sample rate at which the data is sampled shall be assumed to be the same as the transmitted symbol rate and the channel impulse response of the communication channel upon which the symbols are transmitted is represented by:

hₘₗ=[h_{ml,1}, h_{ml,2}, . . . h_{ml,W}]^{T}

### Equation 1

wherein:

m refers to the m-th transmit antenna transducer;

1 refers to the l-th receive antenna transducer; and

W represents the maximum number of communication paths, here assumed to be the same for all radio links.

An over sampling situation is easily accommodated by the structure of the communication system, and the communication channel is assumed to be time-invariant for a data burst duration, and perfectly known at the receiver.

A burst of N symbols sent by the m-th transmit-antenna transducer is represented as:

xₘ=[x_{m,1}, x_{m,2} . . . x_{m,N}]^{T}

### Equation 2

The signal received at the mobile station by the l-th antenna transducer 32 is represented as:

$${r}_{1} = {\sum }_{m = 1}^{M} {H}_{m1} {x}_{m} + {n}_{1} \qquad Equation 3$$

wherein:

n₁is the complex additive white Gaussian noise (AWGN) at the l-th receive antenna transducer and Hₘₗ is the channel matrix corresponding to the m-th transmit antenna transducer and the l-th receive antenna transducer and which has the form:

$${H}_{m 1} = {[ \begin{matrix}{h}_{m 1 , 1} & 0 & ⋯ & 0 \\ {h}_{m 1 , 2} & {h}_{m 1 , 1} & ⋰ & ⋮ \\ ⋮ & {h}_{m 1 , 2} & ⋰ & 0 \\ {h}_{m 1 , W} & ⋮ & ⋰ & {h}_{m 1 , 1} \\ 0 & {h}_{m 1 , W} & ⋰ & {h}_{m 1 , 2} \\ ⋮ & ⋮ & ⋰ & ⋮ \\ 0 & 0 & ⋯ & {h}_{m 1 , W}\end{matrix} ]}_{N + W - 1 \times N} \qquad Equation 4$$

The data symbols that are applied to the space-time encoder is denoted by the x=[x₁, x_{2,} . . . x_{K}]^{T}. With this denotation, the following relation with respect to the space-time encoded symbols is formed:

xₘ=xₘ_{^{R}}+jxₘ_{^{I}}=Pₘx^{R}+jQₘx^{I}

### Equation 5

wherein: Pₘ, Qₘ, are N×K matrices; and

the superscripts R and I denote the real and imaginary parts of the scalar values and matrices of the equation.

The values of xₘ is generated via a morphism from x, involving the Pₘ and Qₘ operators. The matrices P and Q have left inverses of size K×N which, when multiplied together with their counterparts, form an identity matrix of the size K, i.e., Iₖ. With consideration of a conventional space-time block node (STBC), the following equations are represented:

x₁=[x₁x₂]^{T}=I₂x^{R}+jI₂x^{I}

### Equation 6

x₂=[−x₂*x₁*]^{T}

### Equation 7

Equation 6 is exemplary of a data burst of a length of two. An analogous relation can be represented for a longer data burst, e.g., to N, by using a tensor product between the identity matrix and the corresponding P and Q matrices.

Operation of the decoder of an embodiment of the present invention by which to directly combine the values of the data transmitted upon the separate communication paths to the mobile station exploits correlations which exits amongst xₘ vectors. By substituting the values of Equation 5 into Equation 3 above, the following results:

R=Hᵣx^{R}+Hᵢx^{I}+n

### Equation 8

where:

$${H}_{r} = {\sum }_{m = 1}^{M} {H}_{m} {P}_{m} and {H}_{i} = j {\sum }_{m = 1}^{M} {H}_{m} {Q}_{m} \qquad Equation 9$$

Match filtering is then performed, successively using Hᵣ_{^{H}} and Hᵢ_{^{H}}, thereby to yield:

Hᵣ_{^{H}}Hᵣ=yᵣ=R₁ₗx^{R}+R₁₂x^{I}+zᵣ

### Equation 10

Hᵢ_{^{H}}Hᵣ=yᵢ=R₂₁x^{R}+R₂₂x^{I}+zᵢ

### Equation 11

By denoting y_{CD}=[yᵣ_{^{T}}yᵢ_{^{T}}]^{T}, x_{CD}=[(x^{R})^{T}(x^{I})^{T}]^{T} and R_{CD}={Rₖₙ, ∀k,n=1,2} to form:

y_{CD}^{R} x_{CD}+z_{CD}^{R}

### Equation 12

One way to solve Equation 12 is using the inverse of R_{CD}_{^{R}}, i.e.

$${\hat{x}}_{CD} = dec ⌊ {( {R}_{CD}^{R} )}^{- 1} {y}_{CD}^{R} ⌋ \qquad Equation 13$$

Where dec[.] represents the decision device.

Analysis of the above equation indications that estimates of real and imaginary parts of x are given directly, i.e., x_{CD} is a real vector. Operation of the decoder to first directly-combine and then to detect values of the data after all of the information regarding a particular symbol has been properly combined. Improved efficiency of computations required to perform the operations of the decoder is provided by the decoder of an embodiment of the present invention. The dimension of R_{CD}_{^{R}} is 2K×2K which is smaller than the MN×MN used in conventional decoder operation. And, the decoder of an embodiment of the present invention requires only operations to be performed upon real, rather than complex matrices.

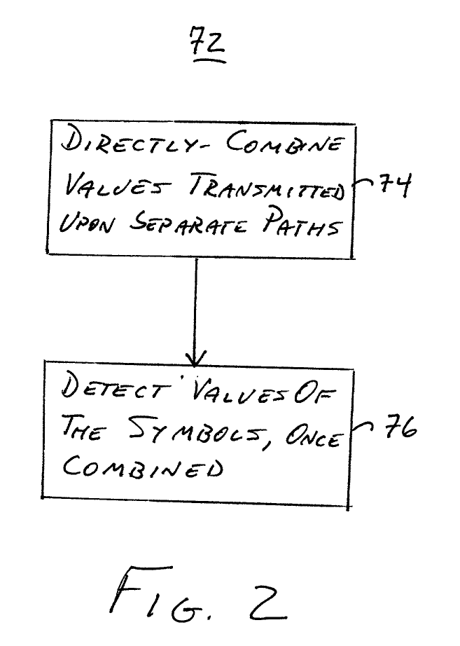

FIG. 2 illustrates a method, shown generally at 72, of an embodiment of the present invention. The method 72 is operable to decode space-time encoded data transmitted at a first and at least a second, to a receive station.

First, and as indicated by the block 74, values of the space-time encoded data transmitted from the different ones of the first and at least locations to the receive station. Then, and as indicated by the block 76, values of the symbols of the data, once combined, are detected.

Through operation of an embodiment of the present invention, space-time encoded data, communicated to the receive station upon two or more communication paths are directly combined and, thereafter, values of the data are detected. Improved computational efficiency is provided pursuant to the decoding technique of an embodiment of the present invention, in contrast to conventional manners by which to perform decoding operations.

The previous descriptions are of preferred examples for implementing the invention, and the scope of the invention should not necessarily be limited by this description. The scope of the present invention is defined by the following claims.

What is claimed is:

1. In a communication system in which space-time encoded data is transmitted at a first location and at least at a second location for communication to a receive station, an improvement of apparatus for the receive station for decoding the space-time encoded data received thereat, said apparatus comprising:
a decoder coupled to receive indications of the space-time encoded data received at the receive station, said decoder for directly combining values of the space-time encoded data transmitted from different ones of the first and at least second locations to the receive station and for detecting values of symbols of the data, once combined.

2. The apparatus of claim 1 wherein the space-time encoded data transmitted at the first and at least second locations comprises a space-time encoded block of data, and wherein said decoder directly combines values of the space-time encoded block.

3. The apparatus of claim 2 wherein said decoder further forms a sequence estimate, the sequence estimate formed of detected values of the data, once combined.

4. The apparatus of claim 1 wherein the communication system comprises a radio communication system, wherein the first location at which the space-time encoded data is transmitted comprises a first antenna transducer, wherein the second location at which the space-time encoded data is transmitted comprises a second antenna transducer, the second antenna transducer spaced apart from the first antenna transducer, wherein the receive station comprises a radio receiver, and wherein said decoder is coupled to receive indications of the space-time encoded data received at the radio receiver.

5. The apparatus of claim 4 wherein the space-time encoded data transmitted at the first antenna transducer is transmitted upon a first communication path to the receive station, wherein the space-time encoded data transmitted at the second antenna transducer is transmitted upon a second communication path to the receive station, wherein the receive station comprises at least one receive-antenna transducer coupled to transduce indications of the space-time encoded data transmitted upon the first and second communication paths, respectively, into electrical form, and wherein the indications of the space-time encoded data to which said decoder is coupled to receive are in electrical form, subsequent to reception at the receive-antenna transducer.

6. The apparatus of claim 1 wherein the directly-combined values of the space-time encoded data formed by said decoder comprise a real-valued component portion and an imaginary-valued component portion.

7. The apparatus of claim 6 wherein detected values of the symbols of the data, once combined, formed by said decoder comprise a detected value of the real-valued component portion and a detected value of the imaginary-valued component portion.

8. The apparatus of claim 7 wherein the receive station further comprises a detected-data value operation for operating upon detected data, the detected data upon which said detected-data value operates comprised of the detected values of the symbols formed by said decoder.

9. The apparatus of claim 8 wherein the detected values of the symbols formed by said decoder comprise at least a first block of space-time decoded data symbol values.

10. The apparatus of claim 1 wherein the values of the space-time encoded data transmitted at the first location and values of the space-time encoded data transmitted at the second location are correlated with one another and wherein said decoder includes a matched filter for performing successive matched filter operations upon the indications of the space-time encoded data received thereat.

11. In a method for communicating in a communication system in which space-time encoded data is transmitted at a first location and at least a second location for communication to a receive station, an improvement of a method for decoding the space-time encoded data, once received at the receive station, said method comprising:
directly combining values of the space-time encoded data transmitted from different ones of the first and at least second locations to the receive station; and
detecting values of symbols of the data, once combined during said operation of directly combining.

12. The method of claim 11 wherein the space-time encoded data transmitted at the first and at least second locations comprises a space-time encoded block of data and wherein said operation of directly combining comprises directly combining values of the space-time encoded block.

13. The method of claim 12 further comprising the operation of forming a sequence estimate, the sequence estimate formed of detected values of the data detected during said operation of detecting.

14. The method of claim 11 wherein the communication system comprises a radio communication system, wherein the first location at which the space-time encoded data is transmitted comprises a first antenna transducer, wherein the second location at which the space-time encoded data is transmitted comprises a second antenna transducer, the second antenna transducer spaced apart from the first antenna transducer, wherein the receive station comprises a radio receiver, said operation comprising the further operation, prior to said operation of directly combining, of receiving indications of the space-time encoded data at the radio receiver.

15. The method of claim 14 wherein the space-time encoded data transmitted at the first antenna transducer is transmitted upon a first communication path to the receive station, wherein the space-time encoded data transmitted at the second antenna is transmitted upon a second communication path to the receive station, wherein the receive station comprises at least one receive antenna transducer and wherein said operation of receiving comprises transducing indications of the space-time encoded data transmitted upon the first and second communication paths, respectively, into electrical form.

16. The method of claim 11 wherein directly-combined values of the space-time encoded data formed during said operation of directly combining comprises a real-valued component portion and an imaginary-valued component portion.

17. The method of claim 16 wherein detected values of the symbols of data detected during said operation of detecting comprise a detected value of the real-valued component portion and a detected value of the imaginary-valued component portion.

18. The method of claim 17 further comprising the operation of operating upon detected data formed during said operation of detecting.

19. The method of claim 18 wherein the detected values of the symbols formed during said operation of decoding comprise at least a first block of space-time decoded data symbol values.

20. The method of claim 11 wherein values of the space-time encoded data transmitted at the first location and values of the space-time encoded data transmitted at the second location are correlated to one another and wherein said method further comprises the operation of performing successive matched filter operations upon the indications of the space-time encoded data received thereat.
